(19) United States
(12) Patent Application Publication
(10) Pub. No.: US 2022/0147391 A1
(43) Pub. Date: May 12, 2022

(54) Cloud Resource Monitor and Interface Method and System for Containerized Applications

(71) Applicant: Trilio Data, Inc., Framingham, MA (US)

(72) Inventors: Muralidhara R. Balcha, Holliston, MA (US); Prashanto Jairaj Kochavara, Boston, MA (US); David Safaii, Sherborn, MA (US); Seema Patwardhan Karandikar, Mumbai (IN); Madhur Nawandar, Pune (IN)

(73) Assignee: Trilio Data, Inc., Framingham, MA (US)

(21) Appl. No.: 17/521,922

(22) Filed: Nov. 9, 2021

Related U.S. Application Data
(60) Provisional application No. 63/112,966, filed on Nov. 12, 2020.

(51) Int. Cl. G06F 9/50; G06F 11/34; G06F 11/14

(52) U.S. Cl. CPC G06F 9/5005; G06F 11/1469; G06F 11/3433

(57) ABSTRACT

A computer-implemented method for providing cloud resource monitor interfaces for containerized applications includes portraying a hierarchy of monitored cloud resources and identifying a request to display system metrics for a selected set of monitored cloud resources in the hierarchy. One or more application tools associated with the selected set of monitored cloud resources are discovered. The discovered one or more application tools associated with the selected set of monitored cloud resources are portrayed in a first window where each of the one or more application tools are represented by a corresponding symbol presented in the first window such that the one or more application tools can be selected. The one or more system metrics of each of the one or more application tools portrayed in the first window using at least one attribute of the corresponding symbol of the one or more application tools such that system metrics of the one or more application tools can be compared so that a comparison results in a selected set of application tools being determined. A request to display summary system metrics for the selected set of application tools based on the comparison and portraying summary system metrics for the selected set of application tools is identified in a second window.

### CROSS REFERENCE TO RELATED APPLICATION

The present application is a non-provisional application of U.S. Provisional Patent Application No. 63/112,966, filed on Nov. 12, 2020, entitled “Cloud Resource Monitor and Interface Method and System for Containerized Applications”. The entire contents of U.S. Provisional Patent Application No. 63/112,966 are herein incorporated by reference.

The section headings used herein are for organizational purposes only and should not be construed as limiting the subject matter described in the present application in any way.

### INTRODUCTION

OpenStack® and other cloud-based deployments are growing at an astounding rate. Furthermore, these deployments are relying more on containerized applications. Market research indicates that a large fraction of enterprises will be deploying some form of cloud infrastructure to support applications services, either in a public cloud, private cloud or some hybrid of a public and a private cloud. This trend leads more and more organizations to use this type of open-sourced cloud management and control software to build out and operate these clouds. Data loss is a major concern for enterprises deploying this and other cloud management and control software. Unscheduled downtime has a dramatic financial impact on businesses. As such, data protection methods and systems are needed which recover from data loss and data corruption scenarios for application workloads executing on OpenStack clouds and/or clouds that execute over containerized environments that use, e.g., Kubernetes® and/or OpenShift®.

One challenge is that the systems and applications being protected may scale to very large numbers of nodes and those nodes may be widely distributed. Thus, data protection systems must be able to scale rapidly both up and down to effectively work across cloud-based application deployments. Another challenge is the ability to efficiently monitor and control these cloud-based application deployments. For example, discovering and keeping track of the resources being utilized by one or more services associated with an organization is challenging in a cloud environment at least in part because resources change over time.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1A illustrates a block diagram of an embodiment of a computer system for cloud resource monitor and interface of the present teaching.

FIG. 1B illustrates a block diagram of an embodiment of an interface system for computer system for cloud resource monitor and interface of the present teaching.

FIG. 2 illustrates a containerized application stack for an application to be monitored and/or backed up executing using a Kubernetes cluster of the present teaching.

FIG. 3 illustrates an embodiment of a display associated with a computer system for cloud resource monitor and interface of the present teaching.

FIG. 4 illustrates an embodiment of a display associated with a computer system for cloud resource monitor and interface of the present teaching that utilizes hexagonal symbols.

FIG. 5A illustrates some example embodiments of symbols portrayed in a display with an application tools view of a computer system for cloud resource monitor and interface of the present teaching.

FIG. 5B illustrates an example embodiment of symbols portrayed on a display with an application tools view on a hover of a computer system for cloud resource monitor and interface of the present teaching.

FIG. 5C illustrates an example embodiment of symbols portrayed on a display with an application tools view with scheduling policies of a computer system for cloud resource monitor and interface of the present teaching.

FIG. 6A illustrates an example embodiment of symbols portrayed on a display with a labels view of a computer system for cloud resource monitor and interface of the present teaching.

FIG. 6B illustrates an example embodiment of symbols portrayed on a display with an objects view of a computer system for cloud resource monitor and interface of the present teaching.

FIG. 6C illustrates an example embodiment of symbols portrayed on a display with a backup plan view of a computer system for cloud resource monitor and interface of the present teaching.

FIG. 7 illustrates some features of an embodiment of a user interface of a computer system for cloud resource monitor and interface for specifying, initiating, performing and/or monitoring a backup and/or restore of the present teaching.

FIG. 8 illustrates a flow chart of the steps of a method for cloud resource monitor and interface for specifying, initiating, performing and/or monitoring a backup of the present teaching.

FIG. 9 illustrates a flow chart of the steps of a method for cloud resource monitor and interface for specifying, initiating, performing and/or monitoring a restore of the present teaching.

FIG. 10 illustrates an embodiment of a display associated with a computer system for cloud resource monitor and interface where a particular set of monitored resources exceeds a particular number of the present teaching.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings may be performed in any order and/or simultaneously as long as the teaching remains operable. Furthermore, it should be understood that the system and methods of the present teachings can include any number or all of the described embodiments as long as the teaching remains operable.

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Data protection has become an important challenge as enterprises evolve OpenStack, OpenShift and/or Kubernetes and similar projects from evaluation to production. Corporations protect data using backup and recovery solutions to recover data and applications in the event of total outage, data corruption, data loss, version control (roll-back during upgrades), and other events. Software developers utilize data protection techniques for, e.g. version control, quality assurance and other development activities. Organizations typically use internal service-level agreements for recovery and corporate compliance requirements as a means to evaluate and qualify backup and recovery solutions before deploying the solution in production.

While data protection has been an important part of software and computer services for a long time, today's cloud-based and/or containerized systems provide a particular challenge for data protection because a workload, or process, running on the system may be parsed in many different ways, and, therefore, any backup will span those different ways of viewing and assembling the applications supporting the workload. The resource monitoring and interface method and system of the present teaching makes data protection of cloud-based and/or containerized workloads more flexible, scalable and effective for these important emerging software and computer services.

Cloud-based systems offer some application programming interfaces (APIs) that can be used to generate a backup, however, these APIs alone are not sufficient to implement and manage a complete backup solution. In addition, each cloud deployment is unique, at least in part because the systems are modular, with multiple options to implement cloud-based workflows with applications and/or containerized applications. Users have a choice of various hypervisors, storage subsystems, network vendors, projects and various open source management and orchestration platforms. As such, there may not be a common and/or automatic way to organize and compare resources associated with a workload so a user can easily monitor and control backup, restoration, upgrades and migrations. The present teaching provides an efficient way to compare resources by discovering and displaying resources associated with a workload in a single window so that comparisons of those resources can be made. The comparison results in those resources or subset of resources being selected and users can request, for example, summary metrics, backups, restores and/or additional information for those selected resources. This is in contrast to known systems that do not allow easy comparison of resources within and/or across a particular workload and/or set of workloads.

One feature of the present teaching is that is supports the monitoring and interface of cloud-based resources to support data protection for hybrid clouds and also supports application-layer resiliency for container-based workloads. Hybrid clouds include cloud resources and services that combine at least one or more of private cloud resources, third-party cloud resources, public cloud resources, on-premise resources, and/or other cloud-based resources and services. Hybrid clouds may also include at least one or more cloud orchestration platforms.

The method and system of the present teaching provides monitoring and interfacing with cloud-based resources to provide efficient data protection operations, including backup and restore, for distributed computing environments, such as private and public clouds, private data centers, and numerous hybrids of these environments. The method and system support, for example, data protection, application lifecycle management, infrastructure migration and infrastructure version management for hybrid cloud-based information systems that utilize container-based applications. The technology supports, for example, resources operating with OpenStack and Red Hat® Virtualization environments, and allows systems to be monitored and managed such that they can recover from disasters, migrate tenant workloads, move workloads to new infrastructures and migrate to new infrastructure software distributions.

Resource monitoring according to the present teaching may include monitoring of a cloud computing system, such as, for example, a system that is executing using a Kubernetes and/or OpenShift software platform in a cloud environment. Kubernetes is an open-source project and framework for cloud computing for container orchestration and automated application deployment, scaling and management. Kubernetes is also referred to as K8s. OpenShift is open source software offered by Red Hat, Inc. that is a container application platform based on top of Docker® containers and Kubernetes container cluster manager platforms. However, it should be understood that the present teachings are not limited to use with Kubernetes and/or OpenShift software platforms and that they can apply to any type of cloud-based computing system and/or container environment that makes virtual servers and other virtual computing resources available as a service or platform to customers.

One feature of the method and system of the present teaching is that it can provide resource monitoring that supports simple backup and restore operations using object storage systems as a backup target, or repository. For example, the system and method of the present teaching may utilize scalable cloud-based backup and restoration methods as described in U.S. patent application Ser. No. 16/923,759, which is assigned to the present assignee.

The method and system of resource monitoring of the present teaching may operate using a cloud-native, application-centric data protection platform to support multiple levels of scale and mobility requirements of modern cloud-based processing. The method and system of resource monitoring of the present teaching supports various constructs that may be found in a cloud environment including multi-tenancy, context awareness and geographically distributed architectures. Moreover, cloud workloads today span multiple virtual machines (VMs), so resource discovery supports workloads that span multiple VMs.

Some embodiments of the methods of the present teaching support backup and recovery of an entire application, including data, metadata and any other objects associated with the application. This includes, for example, configuration files, log files (Nova, Neutron, Cinder), applications, security groups and network configurations, storage volumes, and/or data & metadata. Some embodiments support restorations from any point-in-time backups.

Also various embodiments of the present teaching support various combinations of cloud resource backup and recovery, migration, disaster recovery and mobility applications. This includes, for example, backup and recovery requirements, tenant-administered backup and recovery, non-disruptive incremental backups, instant restore, backup and recovery of single and/or multi-VM workloads, validated backups, efficient data transfer of backup images, and/or disaster recovery. Embodiments of the present teaching support these applications for individual data items, full application workloads and/or entire cloud environments. Also, embodiments of the present teaching may replicate and restore individual workloads, reuse environments for test and development purposes, and selectively restore files that disappear or become corrupted. Furthermore, embodiments of the present teaching support mixed workloads, e.g. part stateless and part stateful applications, and thus support data protection of applications, metadata, and/or the data associated with the application.

One feature of the method and system for cloud resource monitoring and interface of the present teaching is that it does not disrupt running workloads in order to respect required availability and performance metrics of the cloud-based applications. In addition to support for full backup abilities, incremental snapshot images may also be supported so that only changes are transferred to storage systems, thus alleviating burdens on backup storage appliances.

Methods and systems of the present teaching apply to monitoring of cloud-based resources associated with workloads implemented in any combination of the configurations described above. As will be clear to those skilled in the art, various aspects of the system and various steps of the method of the present teaching are applicable to various known computing environments, including computing resources and services available in private and public data centers and/or cloud and/or enterprise environments. Various aspects of the system and various steps of the method of the present teaching are applicable to, and may be used in conjunction with, various known control and management software platforms and services that are associated with cloud-based resources.

Throughout this specification, reference is made to both applications and workloads. In general, an application represents software that performs a desired function. A workload, or application workload, also includes all the resources and processes that are necessary, or utilized, to make the application run. A feature of the data protection method and system of the present teaching is that it not only provides for data protection of the application, but also for data protection of the workload associated with that application. A user or end system may, in some embodiments, specify the scope of the data protection. Thus, reference to application, application workload or workload in a particular description does not necessarily limit the scope of the present teaching.

One feature of the present teaching is the recognition that modern applications and/or workloads running on virtual machines and/or using containers have an associated and integral management structure/information that is needed to run them. This management structure is provided, in some cases, by templates. An example template is the Helm® chart in Kubernetes. An effective and efficient backup and restoration solution needs to appropriately discover and maintain this additional information, as well as the associated data of the application. A template is an example of an application tool that manages the entire lifecycle of an application. Inclusion of the Helm chart as an application tool maintains the relevant information to back up and/or restore not only application data, but necessary configuration information to run the application at any desired point in time.

Another feature of the method and system for cloud resource monitoring of the present teaching is that it provides automatic discovery and display of a set of resources associated with one or more categories of resources. In some embodiments, the categories include application tools, labels, objects and/or backup plans, and their associated system metrics, that are associated with a particular set of resources. This categorization of resources allows the system metrics of the applications and, workloads associated with particular application tools, labels, objects and/or backup plans, to be compared. The application tools, labels, objects and/or backup plans can then be selected based on that comparison to provide a summary view and/or to take action on all or some of the resources such as backup, restore, migration and or recovery operations. Because state-of-the-art computer systems and services are complex and include elements that span multiple categories, the ability to discover, display, compare and select by category advantageously improves the efficiency and integrity of interaction with the monitored resources.

In some embodiments, the cloud resources may be part of Kubernetes namespaces and/or clusters. The ability to automatically discover and display a set of application tools, labels, objects and/or backup plans, and their associated system metrics, which are associated with a particular set of resources, is an improvement over prior art systems that require separate code to discover application tools for a particular resource set.

However, these known approaches cannot be easily extended across multiple resource sets nor provide the ability to view and select across the resource sets and/or tools. It is not possible with prior art systems, for example, to view, compare, and individually select amongst a set of different application tools, labels, objects and/or backup plans associated with a particular workload or set of workloads. It is also not possible to select a particular application tool, label, object and/or backup plan (or a set of these elements) associated with a workload or set of workloads and then automatically view any or all of the application tools, labels, objects and/or backup plans associated with a workload or set of workloads. The ability to view and select across the resource sets and/or tools advantageously supports much more efficient and effective backup, recovery, migration and other management of cloud-based resources, especially those that are workload based and/or container based. This is, at least in part, because workload based and/or container-based cloud systems span a wide variety of virtual and physical processing infrastructure.

One feature of the method and system for cloud resource monitoring of the present teaching is that it provides automatic discovery and display of a set of application tools associated with a set of resources. For example, the resources can be clusters and/or namespaces associated with Kubernetes. An application tool is executable code that allows a user to create an application. Application tools may be used to manage an entire lifecycle of an application. An example of an application tool is a Kubernetes operator. Another example of an application tool is a Kubernetes Helm chart. For example, a user can build a Kubernetes cluster using an operator. A Kubernetes application tool may connect Kubernetes nodes. As another example, a SQL (structured query language) application tool can create a storage cluster with a particular desired size and/or version. Thus, a user that is backing up or otherwise managing a set of resources associated with an application tool is not only protecting an application, but additionally, may be protecting a use case and/or a lifecycle of the use case. Providing an equivalent management of this same set of resources using prior art resource monitoring would require many lines of code and is very time consuming and inflexible.

One feature of the method and system for cloud resource monitoring and interface of the present teaching is that it provides automatic discovery and display of a set of objects associated with a set of resources. For example, Kubernetes objects are persistent entities in a Kubernetes system. Objects represent the state of your resources, for example a Kubernetes cluster. Objects can describe, for example, what containerized applications are running and on what machines, virtual or physical, they are running. Objects can describe what additional resources are available to the running applications. Objects can describe policies associated with a particular application, for example, restart policies, upgrades, and/or fault-tolerance. In a Kubernetes system, an object represents, for example, a cluster's desired state.

One feature of the method and system for cloud resource monitoring and interface of the present teaching is that it provides automatic discovery and display of a set of labels associated with a set of resources. As compared to objects, which may be tied to various computing operations, labels are used to tag and/or track and/or organize resources. For example, labels may be attached to objects and specify attributes of those objects. Thus, labels can be used to organize and to select subsets of objects. Labels can also be attached to objects at creation time and subsequently can be added and/or modified at any time. A particular object can have a set of associated labels defined for that object.

One feature of the method and system for cloud resource monitoring of the present teaching is that it provides automatic discovery and display of a set of backup plans associated with a set of resources. As an example, a backup plan can include which application or set of applications are to be backed up, and which pieces of that application or set of applications are to be backed up. A backup plan can include which target storage system is to be used for backup. A backup plan can also include a schedule for backup.

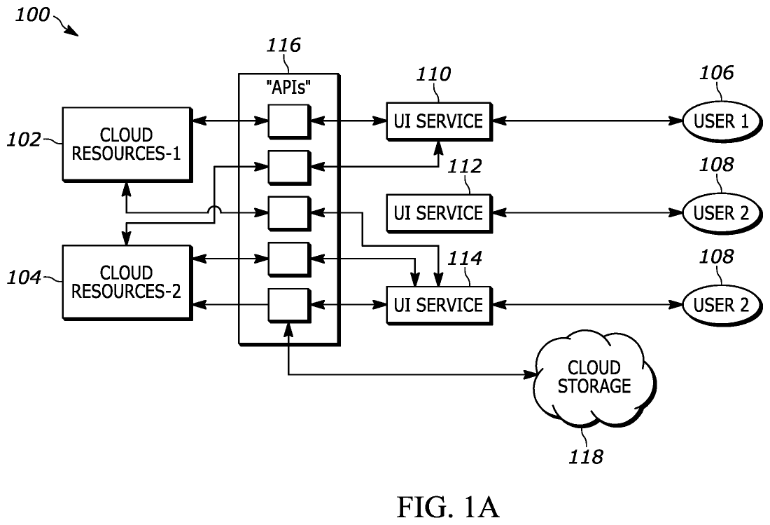

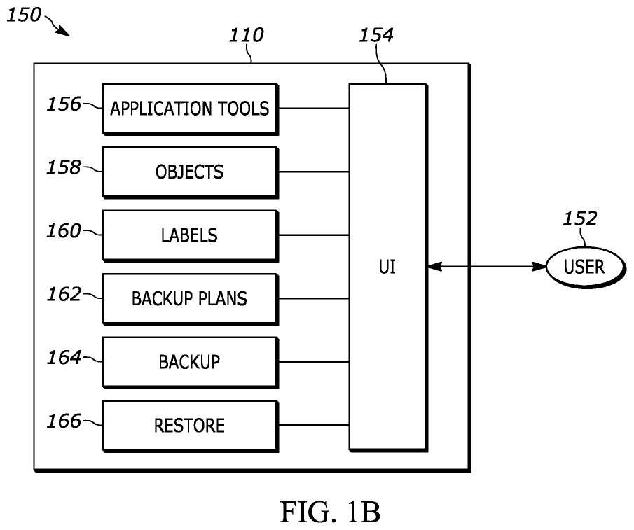

FIG. 1A illustrates a block diagram of an embodiment of a computer system for cloud resource monitor and interface 100 of the present teaching. Cloud resources 102, 104 are being monitored by users 106,108 that interface (i.e. view and interact with) user interface services 110, 112, 114. The cloud resources 102, 104 can include any or all of a variety of computer systems and services offered on any or all of public, private and/or hybrid clouds. In some embodiments, the cloud resources 102, 104 include cloud-based Kubernetes clusters and namespaces. In some embodiments the cloud resources 102, 104 include OpenStack deployments. The cloud resources 102, 104 may be described as a hierarchy of resources based on how these resources are distributed and applied to particular workflows executing by and for users 106, 108. Users 106, 108 may include, for example, any of a variety of business users or operators that use cloud-based computing systems and services, such as small or large enterprises and/or individuals.

The user interface services 110, 112, 114 use application programming interfaces (APIs) 116 to connect to the resources 102, 104. Backup information for the cloud resources 102, 104 is directed to a storage system 118. In some embodiments, the storage system 118 is cloud based storage such as Amazon S3®. The storage system 118 may be referred, in whole or in part, as a target for a backup of application data.

FIG. 1B illustrates a block diagram of an embodiment of an interface system for computer system for cloud resource monitor and interface 150 of the present teaching. A user 152 interacts with a user interface 154, such as a computer display or other processor screen, which is part of a user interface service 110. For example, the service may be the user interface service 110 of FIG. 1A. The user interface service 110 is able to display on the user interface 154 representations of cloud resources (not shown) that are part of a set of desired monitored cloud resources of the user. The resources are parsed using an applications tools engine 156, objects engine 158, labels engine 160 and/or backup plans engine 162. The applications tools engine 156, objects engine 158, labels engine 160 and/or backup plans engine 162 may be used to discover and track all or some of the resources of a particular application, set of applications or workflow being monitored by a user 152 that are part of the respective category type of the engine 156, 158, 160, 162.

The user interface service 110 includes a backup engine 164 that produces backups of selected sets of cloud resources of the user. The user interface 110 includes a restoration engine 166 that produces restoration of backups as selected by the user 152. A feature of the present teaching is the ability to display, in some cases simultaneously, on the user interface 154 any or all of application tools, objects labels, and/or backup plans associated with a particular workload(s) of interest to the user that are operating over cloud resources. This advantageously allows the user to compare the status of these aspects of the resources and also to select various processing actions to take on particular subsets of the resources such as, for example, backup, restore, migration and other recovery operations.

One feature of the present teaching is that it provides a user interface, such as the user interface 154 described in connection with user interface service 110 and the computer system for cloud resource monitor and interface 100 of FIGS. 1A-1B, so that users 106, 108, 152 can view, monitor, and initiate action on various desired sets of cloud resources.

One feature of the method and system for cloud resource monitor and interface of the present teaching is that it is well suited to support containerized workloads that run on cloud-based Kubernetes clusters. In general, Kubernetes runs workloads by placing containers into pods that run on nodes. A node may be a virtual or physical machine, depending on the cluster. Nodes contain the services necessary to run pods and are managed by a Kubernetes control plane. In some cases, there are multiple nodes in a cluster, in other cases there is only one node in a cluster. A Kubernetes cluster is a set of node machines, virtual and/or physical.

Kubernetes supports multiple virtual clusters backed by the same physical cluster that are called namespaces. Namespaces provide a way to divide cluster resources between multiple users. Namespaces provide a scope for names. Names of resources are unique within a namespace, but not across namespaces. Namespaces cannot be nested inside one another and each Kubernetes resource can only be in one namespace.

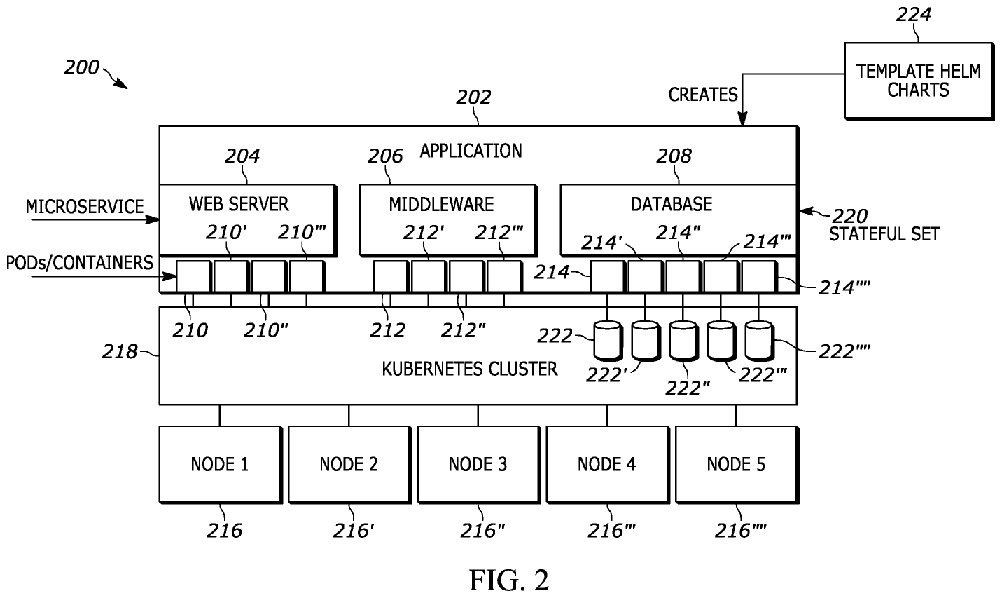

FIG. 2 illustrates a containerized application stack 200 for an application to be monitored and/or backed up executing using a Kubernetes cluster of the present teaching. The application 202 includes three microservices, a web server service 204, a middleware service 206, and a database service 208. Each microservice 204, 206, 208 runs using multiples pods. The web server service 204 uses four pods 210, 210′, 210″, 210′″. The middleware service 206 uses four pods 212, 212′, 212″, 212′″. The database service 208 uses five pods 214, 214′, 214″, 214′″, 214″″. In some embodiments, each pod comprises one or more Docker containers, which is a set of coupled software-as-a-service and platform-as-a-service products that use operating-system-level virtualization to develop and deliver software in containers. The pods 210, 210′, 210″, 210′″, 212, 212′, 212″, 212′″, 214, 214′, 214″, 214′″, 214″″ run on five Kubernetes nodes 216, 216′, 216″, 216′″, 216″″, which may be virtual processing machines or physical processing machines. A Kubernetes cluster 218 manages the pods 210, 210′, 210″, 210′″, 212, 212′, 212″, 212′″, 214, 214′, 214″, 214′″, 214″″ and the nodes 216, 216′, 216″, 216′″, 216″″. The Kubertnetes cluster 218 includes a control plane, that is a collection of processes executing on the cluster, and a master that is a collection of three processes that run on a single one of the nodes 216, 216′, 216″, 216′″, 216″″ on the cluster. The three processes for the master are an API server, controller manager, and a scheduler.

Each application pod 210, 210′, 210″, 210′″, 212, 212′, 212″, 212′″, 214, 214′, 214″, 214′″, 214″″ may have an associated stateful set, and thus, an associated persistent storage volume. This is sometimes referred to as a persistent volume or PV.

Managing storage is distinct from managing computation. A persistent volume (PV) may be a piece of storage in a Kubernetes cluster. The Kubernetes application 202 has a stateful set 220 for the database service 208. The database service 208 pods 214, 214′, 214″, 214′″, 214″″ require ordering and uniqueness. Each pod 214, 214′, 214″, 214′″, 214″″ has an associated persistent volume 222, 222′, 222″, 222′″, 222″″ in the Kubernetes cluster 218. In some embodiments, the persistent volumes are pieces of storage in the cluster that may be provisioned statically by an administrator, or dynamically provisioned using storage classes, or profiles of the storage based on, for example, quality of service, type, and/or backup or other policies.

In some embodiments, the application 202 is created from a template Helm chart 224. Helm is an open-source package and operations manager for Kubernetes. Helm uses Helm charts, such as template Helm chart 224. In general, Helm charts are used to define, install and upgrade Kubernetes applications. Helm charts are used to deploy an application, or one component of a larger application. Each Helm chart is a collection of files in a directory that describe a related set of Kubernetes resources. Helm charts can be simple or complex where they contain many resources. Each chart contains version information in a Chart.yaml file. A Helm chart will usually contain at least a deployment and a service, but it can also contain an ingress, persistent volume claims, or any other Kubernetes object.

The application 202 described in connection with FIG. 2 may be an application that is being backed up and/or restored by various embodiments of the method and system of the present teaching. In addition, or instead, the application 202 described in connection with FIG. 2 may be an application that is executing the backup and/or restore function of various embodiments of the method and system of the present teaching. A feature of applications configured according to an embodiment of FIG. 2 is a cloud-native system that can scale rapidly and efficiently up to large sizes and down to small sizes of nodes and/or other computing elements.

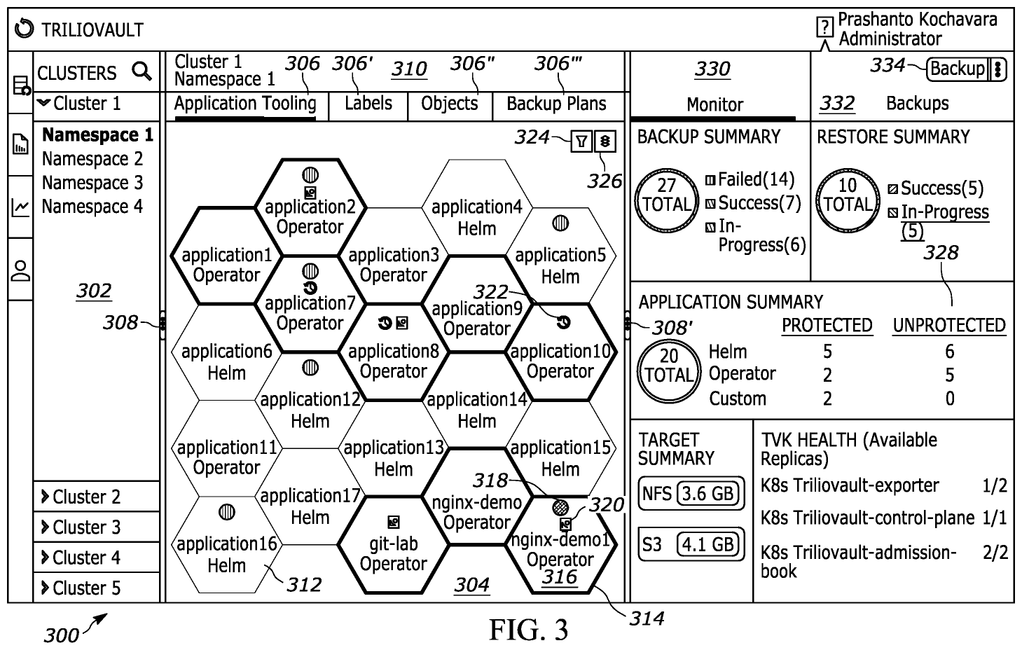

FIG. 3 illustrates an embodiment of a display 300 associated with a computer system for cloud resource monitor and interface of the present teaching. The display includes different regions, referred to as panels, which display and provide various control interfaces for different parts of the system. One panel 302 portrays a hierarchy of the cloud-based resources that may be monitored and controlled. In this embodiment, a hierarchy includes five clusters. Cluster 1 has four namespaces. A user can click on one or more namespaces to select them as a set of desired resources. Another panel 304 portrays one of application tooling, labels, objects or backup plans, based on a tab 306, 306′, 306″, 306′″ that can be selected by a user. Panel size may be adjusted using a slide button 308, 308′. The resources being displayed for a particular selected view are portrayed in a bar 310 at the top of the panel 304.

In the view portrayed in FIG. 3, application tools associated with the selected resources are represented by a plurality of hexagonal symbols 312. A symbol 312 can be clicked on by a user to select. Multiple symbols can be selected. A border effect 314 of a symbol 316 is used to portray that an application tool has at least one successful backup and so is protected. The border effect 314 may be, for example, a green color border, or a thicker border, or other border that is different from a border of a symbol representing an application tool symbol that does not have a successful backup and so is unprotected.

Various icons and symbols may be used inside of a symbol 312, 316 to illustrate status of important system metrics. For example, a dot 318 has a particular attribute, for example a color or fill pattern, to show backup status of the last backup of the application tool. In embodiments where the attribute is color, yellow may be used to indicate backups that are “in process” and red for “failed” backups. An icon 320 is used to show that the application tool has at least one successful restored backup. Another icon 322 is used to show that a backup is scheduled, that item has a scheduling policy for backups. Filter buttons 324, 326 are used to navigate a filter for the application tools based on specific terms (button 324) or to show or hide the details of hexagon layers by toggling the layers on or off (button 326).

A monitor summary panel 328 illustrates various system metric summaries. Tabs 330, 332 are used to switch to determine whether monitors or backups are illustrated at a namespace level. The summary is across all the selected resources. Hovering over a monitor in panel 328 provides an expanded view that portrays more details. Clicking on a backup button 334 allows a user to view, navigate, select and/or initiate backups as desired, as will be described further below. A feature of the present teaching is that a particular view portrayed in panel 304 allows a user to compare system metrics of the resources associated with the particular type (application tools, objects, labels and/or backup plans) in a single view of the display 300.

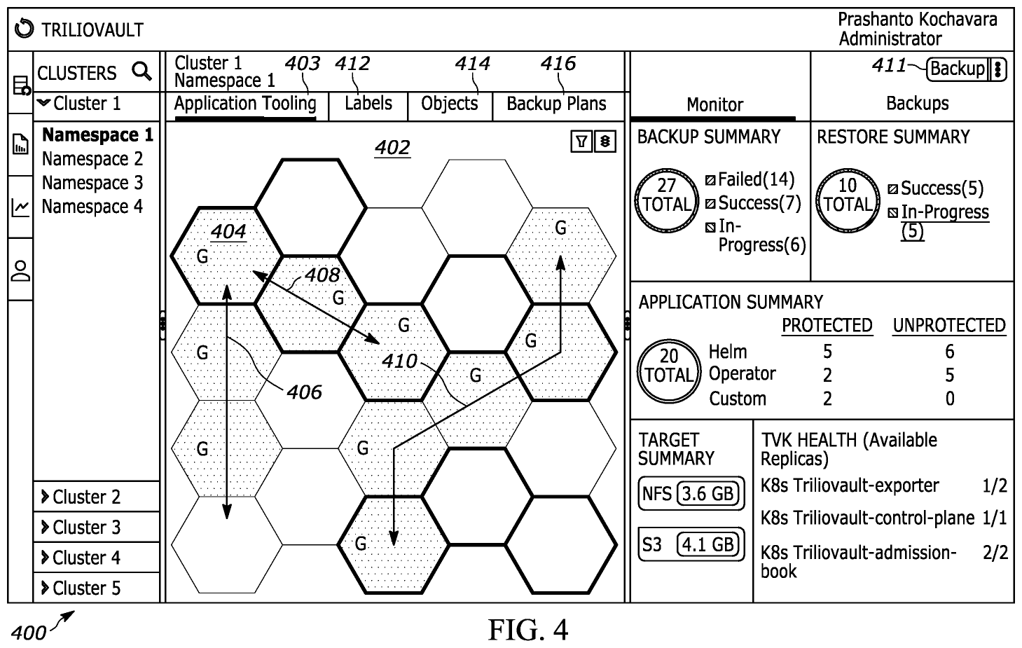

One feature of the present teaching is that the symbols in a panel view of a category can make selection of particular sets of the items in a category simple for the user. FIG. 4 illustrates an embodiment of a display 400 associated with a computer system for cloud resource monitor and interface of the present teaching that utilizes hexagonal symbols. A panel 402 illustrates all the items of a selected namespace (Cluster 1, Namespace 1) in a category of application tooling by selecting application tooling tab 403 as hexagons 404 in a close packed arrangement, also called a honeycomb. The close packed hexagon, or honeycomb, configuration of symbol shape and positioning makes it easy for a user to select multiple application tools. A user is able to select a subset of hexagons by sliding a cursor along various paths, such as example paths 406, 408, 410. In some embodiments, the selected items of a given category type are shown as shaded in the view upon the user interface service identifying that a user had selected the items. In some embodiments, the selected items can then be further portrayed as summary of system metrics and/or actions initiated. In some embodiments the user can initiate a backup of the selection by clicking on a backup button 411.

A feature of the present teaching is that a user can select in a first panel a set of items in a particular category, and the system automatically discovers and populates the associated resources as parsed in a different category so that when a user selects a different tab, e.g. labels tab 412, objects tab 414 or backup plans tab 416, then the panel view for that selection will highlight the items in the category type associated with the same subset of resources as the application tools category. For example, if a particular application tool is selected by a user, when the tab for objects is selected the panel view will display all the objects that are part of that application tool as highlighted. Likewise, every backup plan associated with that application tool is displayed as highlighted when the tab for backup plans is selected. This automatically generated representation of the selected resources across different category types in the different windows or panel views advantageously improves the efficiency and integrity of monitoring as compared to systems that only support the display of resources that are associated with a single category. There are also improvements in interacting with and changing the monitored resources. It saves the user from having to discover each of the resource categories separately and then cross referencing those that share resources.

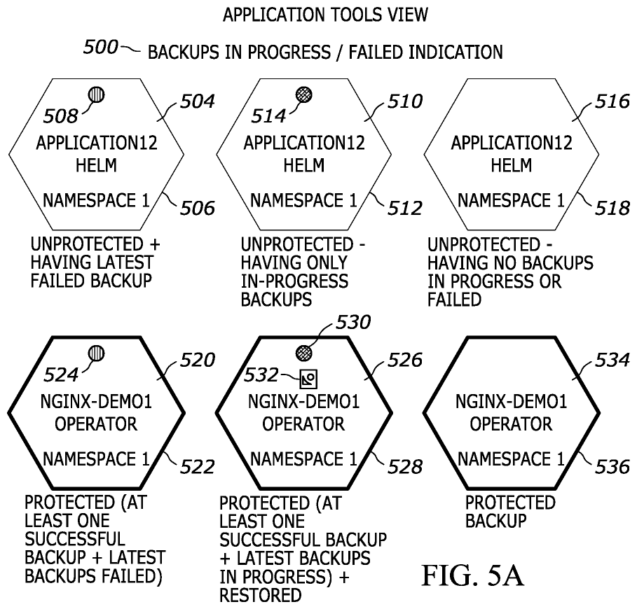

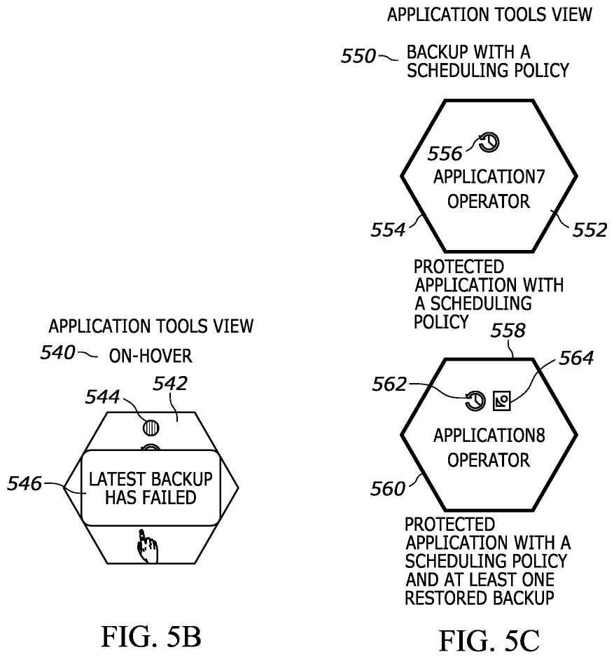

FIG. 5A illustrates some example embodiments of symbols 500 portrayed in a display with an application tools view of a computer system for cloud resource monitor and interface of the present teaching. The symbols 500 represent application tools with backups in progress and/or in failed conditions. A symbol 504 for an unprotected application tool whose last backup failed has a plain border 506 and a dot 508 with a fill indicating failed backup, which may be, for example, a red color. Inside the symbol 504, text is provided that indicates the application number of the application tool, the fact that it is a Helm operator, and the namespace with which it is associated, in this example, Namespace 1.

A symbol 510 for an unprotected application tool that only has backups in progress has a plain border 512 and a dot 514 with a fill indicating backup in progress, which may be, for example, a yellow color. Inside the symbol 510, text is provided that indicates the application number of the application tool, Application 12, the fact that it is a Helm operator, and the namespace with which it is associated, in this example, Namespace 1. A symbol 516 for an unprotected application tool that has no backups in progress has a plain border 518 and no dot. Inside the symbol 516, text is provided that indicates the application number of the application tool, Application 12, the fact that it is a Helm operator, and the namespace with which it is associated, in this example, Namespace 1.

Symbol 520 represents a protected application tool that has at least one successful backup and the latest backup failed. This symbol 520 represents an application that has had a successful backup, and so has a thick and/or green border 522. The dot 524 fill indicates failed backup, for example, a red color fill. Inside the symbol 520, text is provided that indicates the application name of the application tool, NGINX-DEMO1, the fact that it is an Operator, and the namespace with which it is associated, Namespace 1. Symbol 526 represents a protected application tool that has at least one successful backup and a backup in progress. This symbol 526 represents an application that has had a successful backup, and so has a thick and/or green border 528. The dot 530 fill indicates a backup in progress, e.g. yellow fill color. Inside the symbol 526, text is provided that indicates the application name of the application tool, NGINX-DEMO1, the fact that it is an Operator, and the namespace with which it is associated, Namespace 1. Symbol 534 represents an application tool that is protected and has no backups in progress or failed. This symbol 534 represents an application that has had a successful backup, and so has a thick and/or green border 536. Inside the symbol 534, text is provided that indicates the application name of the application tool, NGINX-DEMO1, the fact that it is an Operator, and the namespace with which it is associated, Namespace 1.

FIG. 5B illustrates an example embodiment of symbols 540 portrayed on a display with an application tools view on a hover of a computer system for cloud resource monitor and interface of the present teaching. The example symbol 542 appears on a hover of a cursor or pointer over the screen on the symbol 504 of FIG. 5A. In general, hovering over a symbol is used to elicit additional detail to the user about an application tool that is represented by a symbol. The user interface recognizes a hover and changes the display in response to the hover event. The example symbol 542 represents an application tool with a failed backup. This is indicated by a dot 544 with a fill indicating failed backup, for example, a red color fill. The hover action produces a textbox 546 that states the latest backup has failed.

FIG. 5C illustrates an example embodiment of symbols 550 portrayed on a display with an application tools view with scheduling policies of a computer system for cloud resource monitor and interface of the present teaching. This symbol set 550 represents application tools that are backed up using a scheduling policy. Symbol 552 illustrates a protected application with a scheduling policy. This symbol 552 represents an application that has had a successful backup, and so has a thick and/or green border 554. An icon 556 in a timer shape is used to indicate that this application, Application7, has a scheduling policy that sets specific backup times for the application.

Symbol 558 illustrates a protected application with a scheduling policy and at least one restored backup. This symbol 558 represents an application that has had a successful backup, and so has a thick and/or green border 560. An icon 562 in a timer shape is used to indicate that this application, Application8, has a scheduling policy that sets specific backup times for the application. Another icon 564 shape is used to indicate that this application has a restored backup. As is clear to those skilled in the art, other icon shapes than those pictured in the figures may be used. The present teaching is not limited to particular shapes or numbers of icons.

While the example symbols FIGS. 5A-C are illustrated for a display embodiment that represents application tools, the extension to representations using symbols, attributes, icons and dots to labels, objects, backup plans and or other category types is understood by straightforward extension.

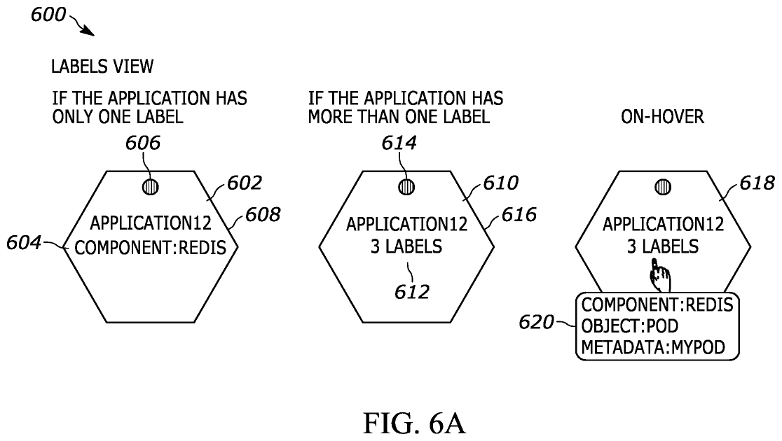

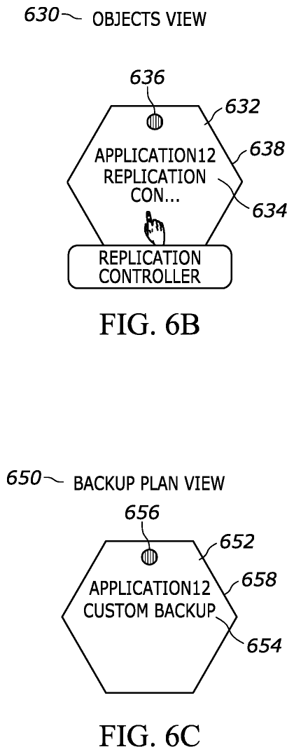

FIG. 6A illustrates an example embodiment of symbols 600 of a display with a labels view of a computer system for cloud resource monitor and interface of the present teaching. Symbol 602 illustrates a case where the application, Application 12, has only one label, component: redis. This label is spelled out in text 604 inside the symbol 602. The label represented by the symbol 602 has a failed backup, and so shows dot 606 with a fill, e.g. red fill. The label represented by the symbol 602 has no backups, and so is unprotected, and the border 608 is thin and/or has no color or other attribute that represents a label with at least one successful backup. Symbol 610 illustrates a case where the application, Application 12, has more than one label, in this case three labels, which is indicated in text 612 in the symbol 610. The label represented by the symbol 610 has a failed backup, and so shows dot 614 with a fill, e.g. red fill. The label represented by the symbol 610 has no backups, and so is unprotected, and the border 616 is thin and/or has no color or other attribute that represents a label with at least one successful backup. Symbol 618 illustrates what is portrayed on the display upon a hover. A textbox 620 appears and includes the names of the labels. In this case, there are three labels, named: component: redis, object: pod, and metadata: mypod. The symbols 610, 618 are just examples of symbols and attributes associated with a label type. Other symbols aspects and attributes described herein can be applied to labels.

FIG. 6B illustrates an example embodiment of symbols 630 of a display with an object's view of a computer system for cloud resource monitor and interface of the present teaching. Symbol 632 illustrates a case where the application, Application 12, has only one object, a replication controller. This object is spelled out in text 634 inside the symbol 632. The object represented by the symbol 632 has a failed backup, and so shows dot 636 with a fill, e.g. red fill. The object represented by the symbol 632 has no backups, and so is unprotected, and the border 638 is thin and/or has no color or other attribute that represents a label with at least one successful backup. In some embodiments, a symbol, such as symbol 632, displays an object (or application tool, label, backup plan or other category type) name of fifteen characters. If there are more than fifteen characters, ellipses and/or ‘_’ is presented after the first twelve characters. In these cases, a hover can uncover the full name. For example, a hover over symbol 632 results in a textbox 640 on the display with the full name of the object, replication controller, spelled out. The symbol 632 is just one example of a symbol and attributes associated with an object type. Other symbols aspects and attributes of the present teaching can be applied to objects.

FIG. 6C illustrates an example embodiment of symbols 650 of a display with a backup plan view of a computer system for cloud resource monitor and interface of the present teaching. Symbol 652 illustrates a case where the application, Application 12, has only one backup plan, a custom backup. This backup plan is spelled out in text 654 inside the symbol 652. The backup plan represented by the symbol 652 has a failed backup, and so shows dot 656 with a fill, e.g. red fill. The backup plan represented by the symbol 652 has no successful backups, and so is unprotected, and the border 658 is thin and/or has no color or other attribute that represents a label with at least one successful backup. As is clear to those skilled in the art, various changes in sizes, shapes, thicknesses, styles, positions, fills, etc. of symbols, text, icons and attributes as compared to those presented herein are possible without departing from the inventive subject matter. The exact details of these features reflect personal preferences of the designer and users.

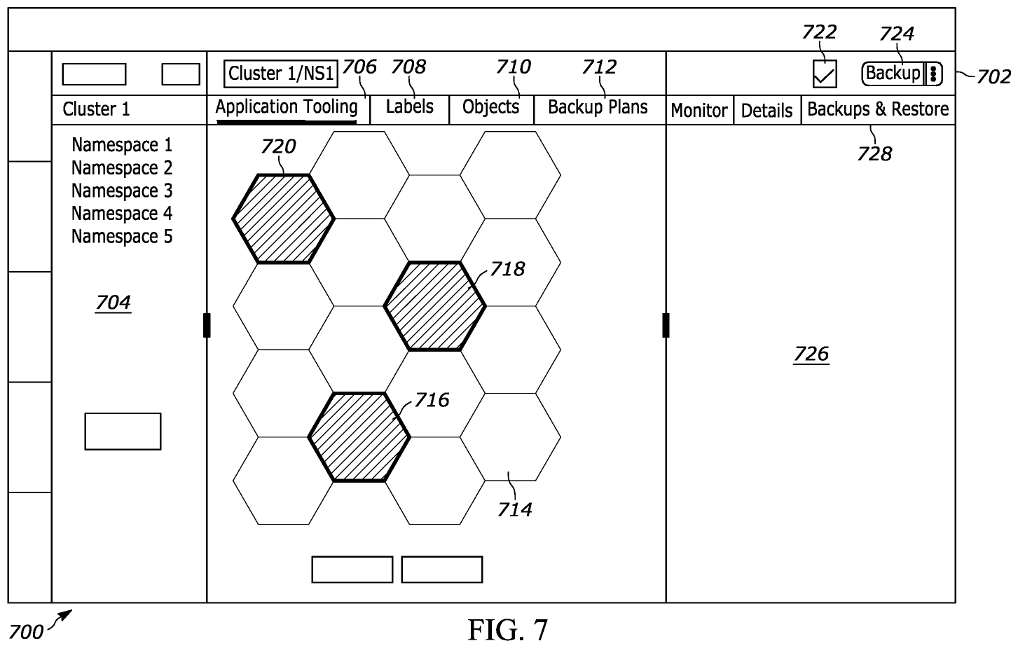

FIG. 7 illustrates features of an embodiment of a user interface display 700 of a computer system for cloud resource monitor and interface for specifying, initiating, performing and/or monitoring a backup and/or restore of the present teaching. A graphical user interface window 702 may portray items similar to those described in connection with the display associated described in connection with FIG. 3. The window 702 portrays information about a selected set of monitored cloud resources by showing a resource hierarchy of those resources in one region 704. The user can select a desired view of different category types by clicking a tab, application tooling tab 706, labels tab 708, object tab 710, and backup plans tab 712. The user can select particular ones of the items displayed as backup desired for the selected category type by clicking a symbol 714. In FIG. 7, symbols 716, 718, 720 are selected and illustrated by shading. The user may peruse multiple category type views and select desired backup items in each view by switching views by clicking the appropriate tab 706, 708, 710, 712. The user then may click on a “done” button 722 to complete selection of particular items.

A list of targets is displayed on a region 726 of the window. For example, a drop-down menu may be presented to the user (not shown). The user selects a target from the list of targets. The target may be, for example, cloud storage, such as S3 object store target. In various embodiments, a region 726 of the window may display optional selections for the user. For example, available backup policies may be presented that the user can select, and the UI system recognize as selected and automatically apply in subsequent processing steps. For example, available retention policies may be presented that the user can select, and the UI system recognize as selected and automatically apply in subsequent processing steps. When various required and optional aspects of the backup have been selected, the user can then click on a backup button 724 to initiate a backup to the selected target.

To specify, initiate, and/or monitor a restore operation, a user clicks on a backup and restore button 728. A window region 726 will provide a list of backups (not shown) that can be restored, and the user can select only one of the backups. In some embodiments, the user is presented with or can generate a backup name that is based on the backup name (not shown). In some embodiments, the user is presented in the region 726 a list of restore namespaces, and the user can select a namespace for the restore (not shown). In some embodiments the region 726 displays information on the progress of the restoration (not shown).

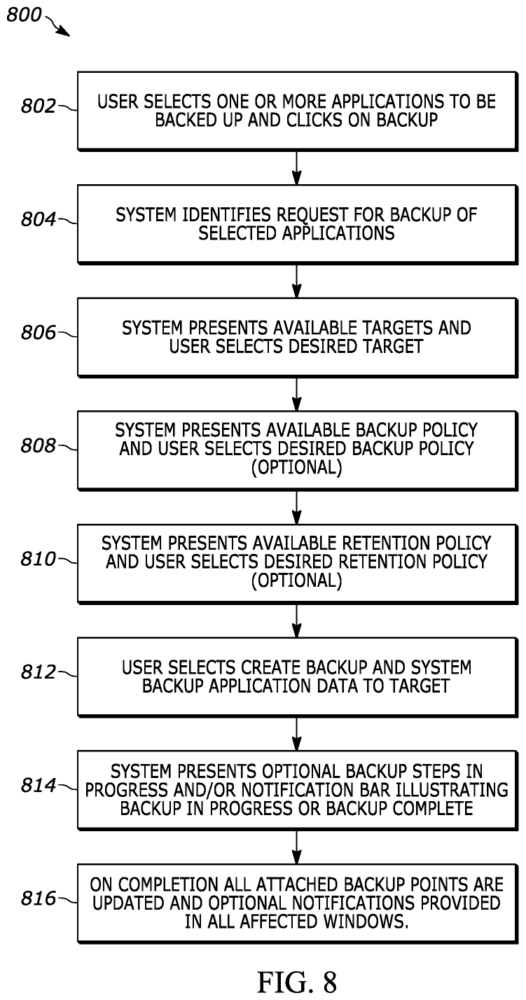

FIG. 8 illustrates a flow chart 800 of the steps of a method for cloud resource monitor and interface for specifying, initiating, performing and/or monitoring a backup of the present teaching. In some embodiments, the steps are performed in connection with a user interfacing with a user interface as described herein. For example, display features that are illustrated in FIGS. 3-7. In a first step 802, a user selects one or more applications desired to be backed up as identified by one or more of application tools, labels, objects, and backup plans. This step can be performed by a user interacting with a UI service, such as UI service 110, 112, 114, described in connection with FIG. 1A. For example, a user may click on one or more symbols in one or more windows that illustrate one of these categories, and the attributes (e.g. protected/unprotected, various backup status, etc.), for comparison by the user. Thus, the user can quickly and easily select desired applications as portrayed in various category types to specify and/or initiate a backup operation.

In a second step 804, the system identifies the request to back up selected applications. Selected applications are portrayed in some embodiments as greyed out. In a third step 806, the system presents in a window available targets for the backup and the user selects a desired target. In an optional fourth step 808, the system presents available backup policies to the user in a window, and the user selects desired backup policies for the backup. In an optional fifth step 810, the system presents available retention policies to the user in a window and the user selects desired retention policies for the backup. In a sixth step 812, the user selects create a backup, for example, by clicking on a backup button, and the systems backs up the application data as specified by the user to the specified target.

In a seventh step 814, the system presents optional backup steps that are in progress in a window. In some embodiments some or all of steps two through seven 804, 806, 808, 810, 812, 814 are performed by a backup engine, e.g. backup engine 164 as described in connection with FIG. 1B. The system may also, optionally, provide a notification bar that illustrates a backup in progress and/or percent complete information. In an eight step 816, upon completion of a backup, all attached backup points are updated and optional notifications are provided in all windows that represent affected information. For example, if a backup fails, a dot fill in a symbol associated with a particular application, and associated category, may be turned to display a shading or color associated with a failed backup. As another example, upon a successful backup, a border of a symbol may change from a thin border to a thick and/or colored border that illustrates that an application and associated category represented by the symbol are protected.

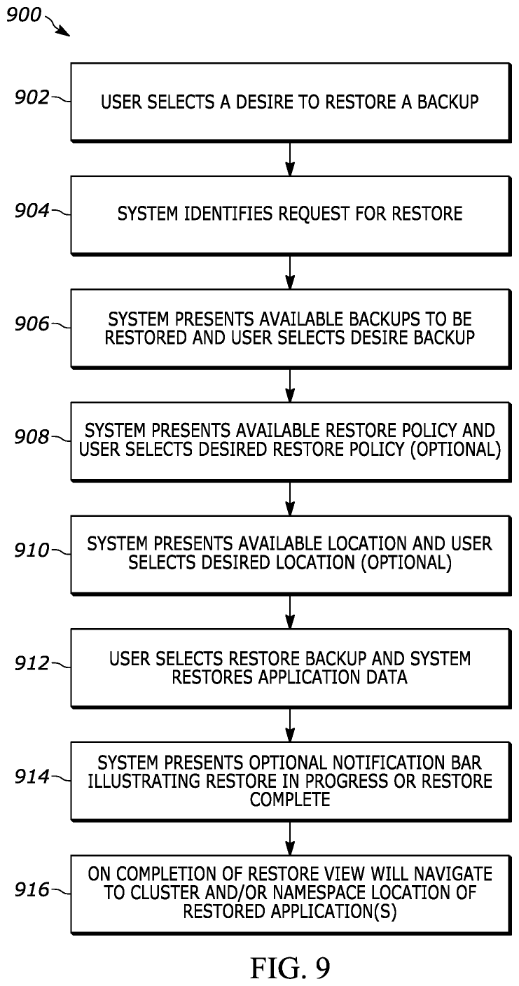

FIG. 9 illustrates a flow chart 900 of the steps of a method for cloud resource monitor and interface for specifying, initiating, performing and/or monitoring a restore of the present teaching. In a first step 902, the user indicates a desire to restore a backup. For example, the user may select a tab for backup and restore and/or click on a restore button in a window. In a second step 904, the system identifies the request for restore. In a third step 906, the system presents available backups that can be restored to a user in a window and the user selects a desired backup to be restored. In a fourth step 908, which is an optional step, the system presents in a window available restore policy and the user selects a desired restore policy. In an optional fifth step 910, the system presents, in a window, available locations for the restore (e.g. a namespace). In a sixth step 912, the user indicates the desire to restore the backup by, for example, clicking a button, and in response, the system identifies the initiation request and restores the application data. In a seventh step 914, the system presents optional notification bar and/or percent complete indication on a window. In an eight step 916, upon completion of the restore, a view may be presented by the system that allows a user to navigate to a cluster and/or namespace location of a restored application or applications. In some embodiments some or all of steps two through eight 904, 906, 908, 910, 912, 914, 916 are performed by a restore engine, such as the restore engine 166 described in connection with FIG. 1B.

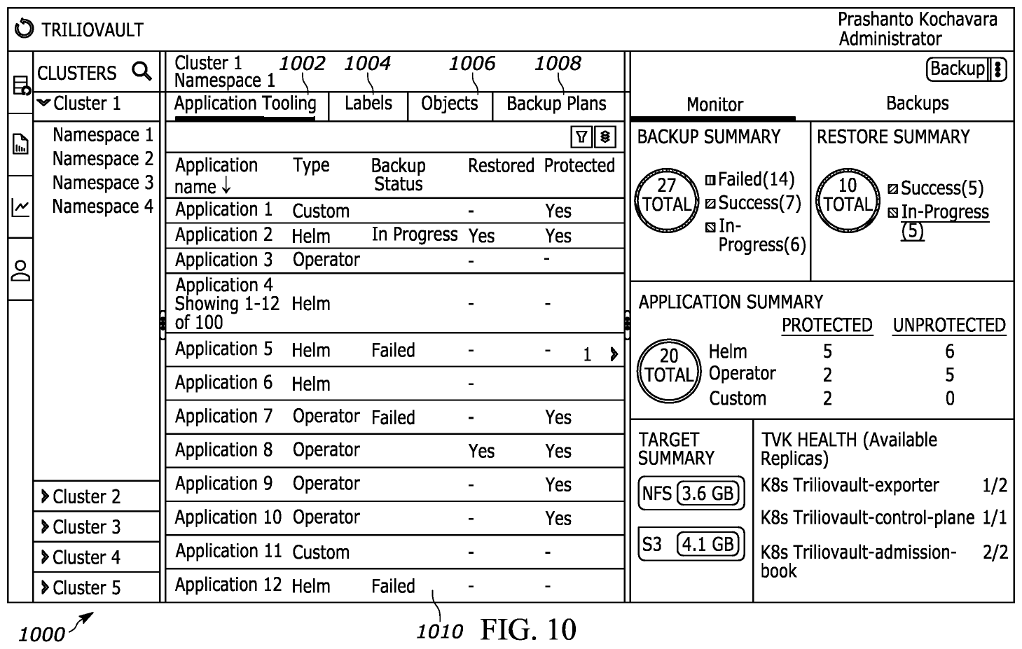

FIG. 10 illustrates an embodiment of a display 1000 associated with a computer system for cloud resource monitor and interface where a particular set of monitored resources exceeds a particular number of the present teaching. In this view, rather than symbols, the applications associated with a category as selected by a tab 1002, 1004, 1006, 1008 are illustrated in a list format. In a particular line 1010, the same or similar information associated with an item in the category is presented as, for example, described in connection with FIG. 3.

While the display mode is visually less symbolic in a list than with the symbol approach, this display 1000 still advantageously allows a user to compare the items within a given category type associated with the application of a selected set of resources within a cloud-based hierarchy of resources. A list view can support more items than a symbol view, because it provides a more compact portrayal of the information. In various embodiments, a display will automatically convert to a list view if the number of applications associated with a set of resources in a particular category being displayed exceeds a particular number. The particular number may be, for example, ten, twelve, twenty or twenty-five items. The number may be based upon a particular size of display that is being used.

### Equivalents

While the Applicant's teaching is described in conjunction with various embodiments, it is not intended that the Applicant's teaching be limited to such embodiments. On the contrary, the Applicant's teaching encompass various alternatives, modifications, and equivalents, as will be appreciated by those of skill in the art, which may be made therein without departing from the spirit and scope of the teaching.

What is claimed is:

1. A computer-implemented method for providing cloud resource monitor interfaces for containerized applications, the method comprising:
a) portraying a hierarchy of monitored cloud resources and identifying a request to display system metrics for a selected set of monitored cloud resources in the hierarchy;
b) discovering one or more application tools associated with the selected set of monitored cloud resources;
c) portraying, in a first window, the discovered one or more application tools associated with the selected set of monitored cloud resources, each of the one or more application tools being represented by a corresponding symbol presented in the first window such that the one or more application tools can be selected;
d) portraying, in the first window, one or more system metrics of each of the one or more application tools using at least one attribute of the corresponding symbol of the one or more application tools such that system metrics of the one or more application tools can be compared so that a comparison results in a selected set of application tools being determined; and
e) identifying a request to display summary system metrics for the determined selected set of application tools based on the comparison and portraying summary system metrics for the selected set of application tools in a second window.

2. The computer-implemented method of claim 1 wherein the set of cloud resources comprises at least one cluster and at least one namespace.

3. The computer-implemented method of claim 2 wherein the at least one cluster comprises a Kubernetes cluster.

4. The computer-implemented method of claim 2 wherein at least one of the one or more application tools associated with the at least one namespace comprises an operator.

5. The computer-implemented method of claim 1 wherein at least one of the one or more application tools comprises a Helm chart.

6. The computer-implemented method of claim 1 wherein the one or more application tools comprise an application tool supplied by one vendor and an application tool supplied by another vendor.

7. The computer-implemented method of claim 1 wherein the system metrics comprise at least one of a backup in progress, a backup complete, a backup failed, a restore in progress, a restore complete, a restore failed, a scheduling policy, a protected state or an unprotected state.

8. The computer-implemented method of claim 1 wherein the summary system metrics comprise at least one of a number of backups in progress, a number of backups complete, a number of backups failed, a number of restores in progress, a number of restores complete, a number of restores failed, a number of protected states and a number of unprotected states.

9. The computer-implemented method of claim 1 wherein the request to display system metrics for a selected set of cloud resource in the hierarchy comprises clicking on items in the portrayed hierarchy of cloud resources.

10. The computer-implemented method of claim 1 wherein the symbol comprises a hexagon shape.

11. The computer-implemented method of claim 1 wherein at least one attribute comprises a border of the symbol.

12. The computer-implemented method of claim 1 wherein at least one attribute comprises an icon positioned within the symbol.

13. The computer-implemented method of claim 1 further comprising:
a) identifying a request to back up at least one of the one or more application tools portrayed in the first window; and
b) changing the system metrics of the at least one of the one or more application tools requested to be backed up and portraying the change in system metrics in the first window by changing at least one attribute of the symbol corresponding to application tools requested to be backed up in response to the identified request.

14. The computer-implemented method of claim 13 wherein the request to back up at least one of the one or more application tool comprises clicking on each of the symbols corresponding to the at least one of the one or more application tools being requested to be backed up and subsequently clicking on a backup button.

15. The computer-implemented method of claim 1 further comprising:
a) identifying a request to restore a backup;
b) identifying a selection of at least one application tool associated with the requested backup portrayed in the first window; and
c) changing the system metrics of the at least one application tool associated with the requested backup and portraying the change in system metrics in the first window by changing at least one attribute of the symbol corresponding to application tools requested to be restored in response to the identified request to restore the backup.

16. The computer-implemented method of claim 15 wherein the request to restore the backup comprises clicking on the symbol corresponding to the at least one application tool and subsequently clicking on a restore button.

17. The computer-implemented method of claim 1 further comprising discovering one or more labels associated with the selected set of cloud resources and portraying in a third window the discovered one or more labels associated with the selected set of cloud resources.

18. The computer-implemented method of claim 17 further comprising selecting an application tool in the first window and presenting in the third window attributes of the one or more labels associated with the selected application tool.

19. The computer-implemented method of claim 1 further comprising discovering one or more objects associated with the selected set of cloud resources and portraying in a third window the discovered one or more objects associated with the selected set of cloud resources.

20. The computer-implemented method of claim 1 further comprising discovering one or more backup plans associated with the selected set of cloud resources and portraying, in a third window, the discovered one or more backup plans associated with the selected set of cloud resources.

21. A computer-implemented method for providing cloud resource monitor interfaces for containerized applications, the method comprising:
a) portraying a hierarchy of monitored cloud resources and identifying a request to display system metrics for a selected set of monitored cloud resources in the hierarchy;
b) discovering one or more labels associated with the selected set of monitored cloud resources;
c) portraying, in a first window, the discovered one or more labels associated with the selected set of monitored cloud resources, each of the one or more labels being represented by a corresponding symbol presented in the first window such that the one or more labels can be selected;
d) portraying, in the first window, one or more system metrics of each of the one or more labels using at least one attribute of the corresponding symbol of the one or more labels such that system metrics of the one or more labels can be compared so that a comparison results in a selected set of labels being determined; and
e) identifying a request to display summary system metrics for the determined selected set of labels based on the comparison and portraying summary system metrics for the selected set of labels in a second window.

22. A computer-implemented method for providing cloud resource monitor interfaces for containerized applications, the method comprising:
a) portraying a hierarchy of monitored cloud resources and identifying a request to display system metrics for a selected set of monitored cloud resources in the hierarchy;
b) discovering one or more object versions associated with the selected set of monitored cloud resources;
c) portraying, in a first window, the discovered one or more object versions associated with the selected set of monitored cloud resources, each of the one or more object versions being represented by a corresponding symbol presented in the first window such that the one or more object versions can be selected;
d) portraying, in the first window, one or more system metrics of each of the one or more object versions using at least one attribute of the corresponding symbol of the one or more object versions such that system metrics of the one or more object versions can be compared so that a comparison results in a selected set of object versions being determined; and
e) identifying a request to display summary system metrics for the determined selected set of object versions based on the comparison and portraying summary system metrics for the selected set of object versions in a second window.

23. A computer-implemented method for providing cloud resource monitor interfaces for containerized applications, the method comprising:
a) portraying a hierarchy of monitored cloud resources and identifying a request to display system metrics for a selected set of monitored cloud resources in the hierarchy;
b) discovering one or more backup plans associated with the selected set of monitored cloud resources;
c) portraying, in a first window, the discovered one or more backup plan associated with the selected set of monitored cloud resources, each of the one or more backup plans being represented by a corresponding symbol presented in the first window such that the one or more backup plans can be selected;
d) portraying, in the first window, one or more system metrics of each of the one or more backup plans using at least one attribute of the corresponding symbol of the one or more backup plans such that system metrics of the one or more backup plans can be compared so that a comparison results in a selected set of backup plans being determined; and
e) identifying a request to display summary system metrics for the determined selected set of backup plans based on the comparison and portraying summary system metrics for the selected set of backup plans in a second window.
